(19) United States
(12) Patent Application Publication
(10) Pub. No.: US 2013/0268936 A1
(43) Pub. Date: Oct. 10, 2013

(54) WORKFLOW MANAGEMENT SYSTEM AND METHOD

(71) Applicants: YU-HUNG HSU, Nantou County (TW); YEH-CHING CHUNG, Taichung City (TW)

(72) Inventors: YU-HUNG HSU, Nantou County (TW); YEH-CHING CHUNG, Taichung City (TW)

(21) Appl. No.: 13/442,250

(22) Filed: Apr. 9, 2012

(51) Int. Cl. G06F 9/46

(52) U.S. Cl. 718/102

(57) ABSTRACT

A workflow management system and a method for managing a procedure of delivery of a workflow object within an organizational framework are introduced. The workflow management system includes a metadata database, an input module and an authorizing module. Given definition of route points in a workflow template, configuration of nodes of each of the route points, and configuration of group data within a workflow template, it is feasible to effectuate a pre-built model whereby conventional workflows can be flexibly corrected and assembled anew, thereby dispensing with the hassles of redefining a workflow or performing a time-consuming process of amending the workflow route points one by one, thereby achieving advantages of smart workflow automated design, such as centralized control, dynamic interception, and quick extension of a secondary workflow route.

### FIELD OF THE INVENTION

The present invention relates to workflow management systems and methods, and more particularly, to a workflow management system and method for managing delivery of a workflow object within an organizational framework.

### BACKGROUND OF THE INVENTION

To develop their corporate scale as well as increase operation speed and sophistication, large and medium-sized enterprises have to be capable of responding to electronic document-signing and delivery system precisely and quickly.

It is difficult to integrate enterprise workflow management, administrative department workflow planning personnel, and technical department workflow designing personnel. Routine workflow connection, which is always intricate and prone to errors, has to be reset in terms of personal preference, authority, event and object, sorting, and rule/route logical compilation whenever a request, such as a document-signing request, a purchase request, a joint document-signing request, an investigation request, a statistical analysis request, or even an absence leave request, is made by an organization or an individual. The resetting process is so intricate and heavy that it requires enormous manpower, and thus delays, blunders, and great loss resulting from underperformance and high risks are not uncommon.

Accordingly, it is imperative to lower the otherwise high risks associated with intricate routine workflows, disorderly assembly, and manual intervention.

### SUMMARY OF THE INVENTION

It is an objective of the present invention to arrange any node within an organizational framework in a manner that the node is not confined to a fixed route, such that during object delivery the system can dynamically fetch the nodes supposed to be included in a route node.

Another objective of the present invention is to specify and simplify all the nodes within a workflow framework and the relationships between the nodes to achieve centralized control, dynamic retrieval, and smart workflow automation of rapid branch extension.

In order to achieve the above and other objectives, the present invention provides a workflow management system for managing a procedure of delivery of a workflow object within an organizational framework. The workflow management system comprises: a metadata database for storing nodal data within an organizational framework and storing at least a workflow template operating between the nodes, the workflow template each having a plurality of route points, the route points each having at least a node, each said workflow template being defined with a group data related to each said node; an input module for receiving the workflow object; and an authorizing module linked to the metadata database and the input module, the authorizing module comprising: a workflow template selection unit for generating according to the at least a workflow template a primary workflow route for the workflow object to operate between the route points; and a workflow extension unit linked to the workflow template selection unit and adapted to extend a secondary workflow route of a higher level in accordance with a feedback from a node of each route point, limitation of the group data related to the node, and the nodal data thereof, so as to operate the workflow object, thereby returning to the primary workflow route upon completion of the secondary workflow route.

In order to achieve the above and other objectives, the present invention further provides a workflow management method for generating a workflow route of a workflow object, comprising the steps of: A: searching for a workflow template matching the workflow object; B: operating the workflow object in accordance with each route point of the primary workflow route of the workflow template; C: extending a secondary workflow route of a higher level in accordance with level sequence data of a node fed back within a group to which the node fed back earliest belongs when route points of the primary workflow route have a plurality of equal-level nodes; and D: operating the workflow object in accordance with the secondary workflow route, and going back to step B upon completion of the operation to continue with the next route point, wherein the workflow template regulates a rule of a sequence of a plurality of nodes during operation of the workflow object, has a plurality of route points each having at least a node, and defines a group data related to each said node.

In an embodiment, the workflow management system further comprises: a field setting unit linked to the metadata database and adapted to configure data related to a sequence of the nodes, the field setting unit comprises: a first field setting unit for configuring an organizational framework serial number of each node within an organizational framework; a second field setting unit for configuring a node serial number of each node within an organizational framework; a third field setting unit for configuring a preceding node serial number in accordance with a preceding information of each node within the organizational framework; a fourth field setting unit for configuring, when each node depends upon another node, a dependent node serial number in accordance with the node being depend upon; a fifth field setting unit for configuring an inheritance node serial number in accordance with a serial number of an inherited node when each of the nodes inherits another node; and a sixth field setting unit for configuring a name of each of the nodes.

Accordingly, given a pre-built model and a control mechanism for group data, static nodal data can be flexibly and dynamically extended. Hence, not only is a workflow highly capable of reconstruction and extension, but the benefits and functions of the workflow are also brought into full play when it comes to corporate structural changes, such as corporate merge and acquisition, reorganization, or incorporation. The above-mentioned benefits further highlight the significance of the pre-built model and workflow application extendibility.

### BRIEF DESCRIPTION OF THE DRAWINGS

Objectives, features, and advantages of the present invention are hereunder illustrated with specific embodiments in conjunction with the accompanying drawings, in which:

FIG. 1 is a functional block diagram of a workflow management system according to an embodiment of the present invention;

FIG. 2 is a flow chart of a workflow management method according to an embodiment of the present invention;

FIG. 3 is a schematic view of departmental framework relationships expressed by nodal data according to an embodiment of the present invention;

FIG. 4 is a schematic view of position framework relationships expressed by nodal data according to an embodiment of the present invention;

FIG. 5 is a schematic view of a workflow route comprising expanded field data related to workflow design info in a design stage according to an embodiment of the present invention;

FIG. 6 is a schematic view of a workflow route comprising expanded field data related to runtime workflow info according to an embodiment of the present invention; and

FIG. 7 is a schematic view of the principle of dynamic automated assembly according to an embodiment of the present invention.

### DETAILED DESCRIPTION OF THE PREFERRED EMBODIMENTS

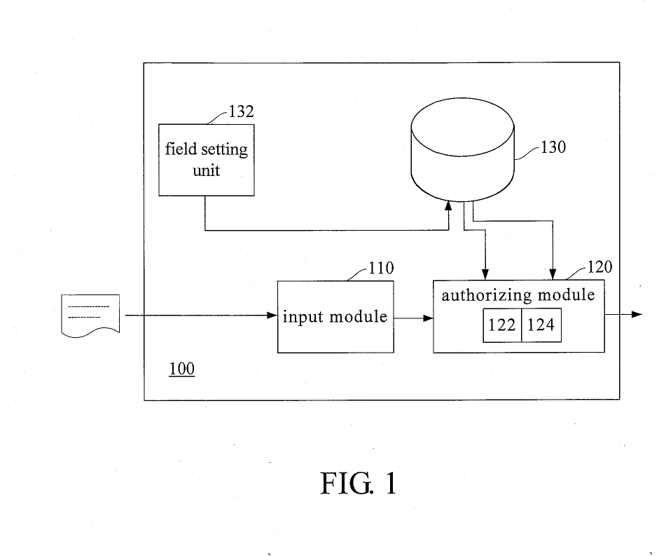

Referring to FIG. 1, there is shown a functional block diagram of a workflow management system 100 according to an embodiment of the present invention. In an embodiment of the present invention, the workflow management system 100, which manages a procedure of delivery of a workflow object within an organizational framework, comprises a metadata database 130, an input module 110, and an authorizing module 120. The organizational framework is an existing hierarchical structure of a user end, such as hierarchical relationships between departments, hierarchical relationships between positions, or hierarchical relationships between companies or organizations. The organizational framework can be depicted with a tree structure. The input module 110 receives the workflow object, using an input interface (such as a network interface) installed in a computer and connected to another computer. The authorizing module 120 is a storage medium disposed in a computer and adapted to store an application for executing a corresponding operation and function.

The metadata database 130 stores nodal data within an organizational framework, such as a storage medium in a computer. Every element within an organizational framework, such as an employee or a supervisor, can be regarded as a node. In an embodiment, the nodal data comprise department info, position info, workflow template design data, and workflow template runtime data.

Furthermore, the metadata database 130 stores at least a workflow template operating between the nodes. Each workflow template has a plurality of route points. The route points each comprise at least a node. Each workflow template is defined with group data related to each node. Hence, when the workflow object operates at the route points by following the rules of a workflow template, at least one secondary workflow route can be extended based on the nodes of the route points and the groups to which the nodes belong.

The input module 110 receives the workflow object.

The authorizing module 120 is linked to the metadata database 130 and the input module 110. The authorizing module 120 comprises a workflow template selection unit 122 and a workflow extension unit 124.

The workflow template selection unit 122 generates a primary workflow route for the workflow object operating between the route points according to the at least a workflow template.

The workflow extension unit 124 is linked to the workflow template selection unit 122 for operating the workflow object and starting the primary workflow route anew at the end of the secondary workflow route.

Once the workflow object enters route points having only a single node, the workflow extension unit 124 will extend the secondary workflow route of a higher level in accordance with a feedback from the single node, for example, the document-signing and approving of the workflow object, a limitation of the group data attributed to the single node and its nodal data. Hence, due to the limitation of the group data, not only is it feasible to define a workflow template with the highest level of the required operation of the workflow object in the secondary workflow route, but it is feasible to come up with the nodal sequence of operation of the secondary workflow route in accordance with the nodal data of the single node.

Once the workflow object enters route points having a plurality of nodes, the workflow extension unit 124 will extend the secondary workflow route of a higher level, in the aforesaid manner, in accordance with the node which is fed back earliest as well as the limitation of the group data attributed to the node which is fed back earliest and its nodal data. Hence, in an embodiment of the present invention, it is feasible to configure a plurality of secondary workflow routes dynamically and achieve dynamic selection of the secondary workflow route in accordance with the node fed back earliest. Furthermore, once a node is fed back, the feedbacks from the other nodes will no longer be valid, and the other nodes will even be configured as incapable of giving feedback anymore. For example, after a supervisor has signed a document, another supervisor at the same level cannot sign the document even though s/he has also received a notice to sign the document.

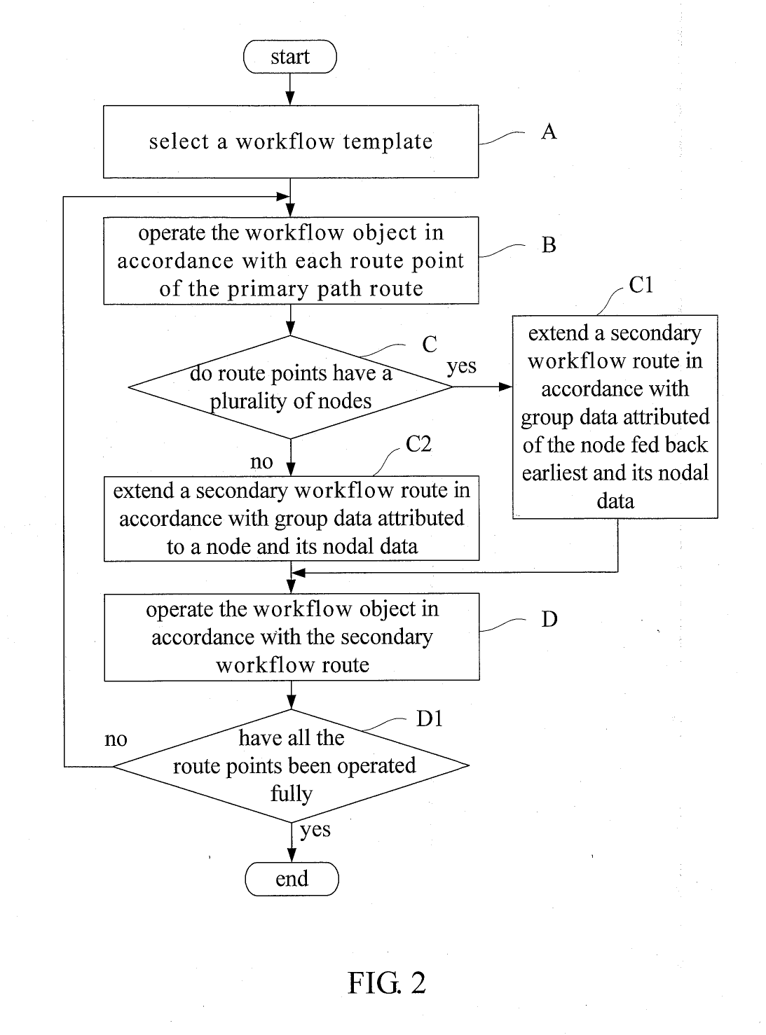

Referring to FIG. 2, there is shown a flow chart of a workflow management method according to an embodiment of the present invention. In an embodiment of the present invention, the workflow management method applies to the aforesaid system and comprises the steps of:

A: select a workflow template of a workflow object;

B: operate the workflow object in accordance with each route point of the primary workflow route of the workflow template;

C: extend a secondary workflow route of a higher level in accordance with level sequence data of a node fed back, wherein step C1 is performed when route points have a plurality of equal-level nodes, and step C2 is performed when route points do not have a plurality of equal-level nodes; and

D: operate the workflow object in accordance with the secondary workflow route and perform step D1 to determine whether all the route points have been operated fully, and go back to step B to operate the next route point in response to a negative determination.

The workflow template sets forth the rule of the sequence of a plurality of nodes during the operation of the workflow object. The workflow template has a plurality of route points. Each of the route points has at least a node. The workflow template defines group data related to each said node.

Accordingly, in an embodiment of the present invention, given the definition of the route points in the workflow template, each of the route points has a node configured and the group data configured in the workflow template to provide a pre-built model, such that a conventional workflow can be flexibly amended and reassembled. In doing so, it dispenses with the hassles of redefining a workflow or performing a time-consuming process of amending the workflow route points one by one, thereby achieving advantages of smart workflow automated design, such as centralized control, dynamic interception, and quick extension of a secondary workflow route.

In a further embodiment, the workflow management system 100 comprises a field setting unit 132. The field setting unit 132 is linked to the metadata database 130, comprising first through sixth field setting units. The field setting units are illustrative of an embodiment of the system and method of the present invention. Other field setting rules are also applicable to the system and method in the preceding embodiments of the present invention.

The first field setting unit configures an organizational framework serial number of each node within an organizational framework. The second field setting unit configures a node serial number of each node within an organizational framework. The third field setting unit configures a preceding node serial number in accordance with preceding information of each node within the organizational framework. The fourth field setting unit configures a dependent node serial number in accordance with another node upon which a node is dependent. The fifth field setting unit configures an inheritance node serial number in accordance with the serial number of an inherited node when a node inherits another node. The sixth field setting unit configures the name of each node.

In an embodiment of the present invention, node information is updated as soon as the field data structure in operation alters any node information in terms of the data structure, such as a supervisor's resignation, to ensure that a workflow object being delivered can be precisely operated.

In an embodiment, the nodal data comprise a department info, a position info, workflow template design data, and workflow template runtime data.

When the nodal data comprise the department info, an embodiment of the present invention is designed as follows: the first field setting unit puts identical organizational frameworks in the same category and configures serial numbers of the same category; the second field setting unit specifies the node serial number as a department serial number; the third field setting unit specifies the preceding information as a supervisory department of the department and sets the department serial number of the supervisory department to the preceding node serial number; the fourth field setting unit configures the dependent node serial number based on the department serial number of the supervisory department; the fifth field setting unit specifies a serial number of an external system as the inheritance node serial number as soon as the department info is imported from the external system; and the sixth field setting unit sets a node name of the department info to a department name.

For example, when the nodal data comprise the department info, it is feasible that a description of the correlation between departments is made. Field data match the field setting units, respectively, as shown in Table 1 below.

TABLE 1
correlation between departments

| field 1 | field 2 | field 3 | field 4 | field 5 | field 6 |
|---|---|---|---|---|---|
| 1 | 1 | | | o1 | president office |
| 1 | 2 | 1 | 1 | o2 | general manager |
| | | | | | office |
| 1 | 3 | 2 | 2 | o3 | department A |
| 1 | 4 | 2 | 2 | o4 | department B |

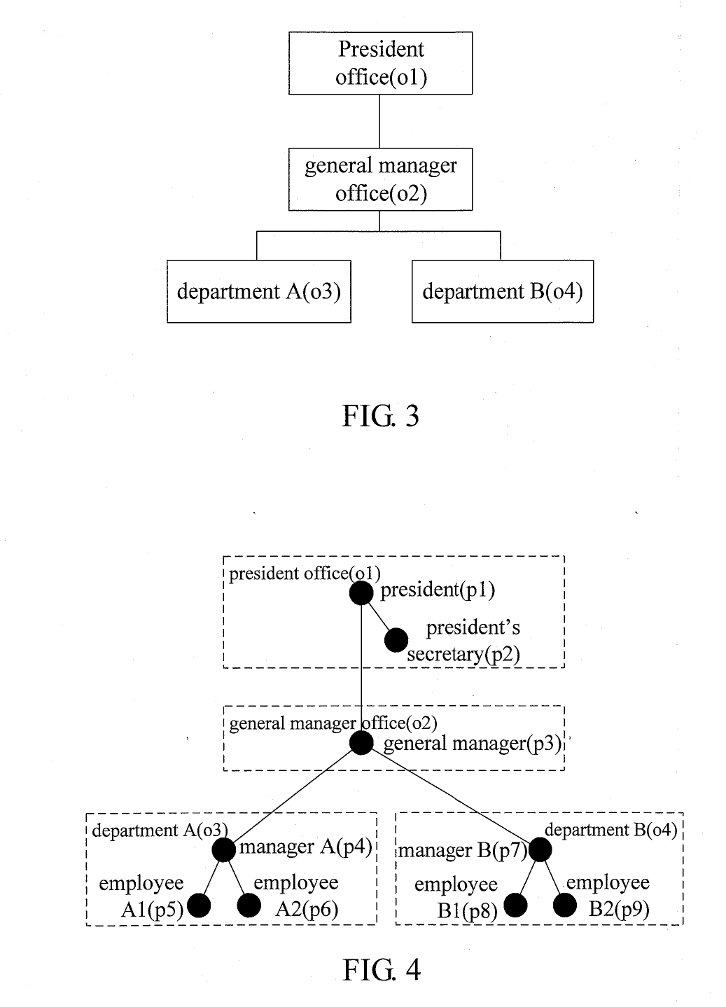

Referring to FIG. 3, there is shown a schematic view of departmental framework relationships expressed by nodal data according to an embodiment of the present invention. When the nodal data comprise the position info, an embodiment of the present invention is designed as follows: the first field setting unit puts identical organizational frameworks in the same category and configures serial numbers of the same category; the second field setting unit specifies the node serial number as a position serial number; the third field setting unit specifies the preceding information as a position of the position-related immediate supervisor and sets the position serial number attributed to the immediate supervisor's position to the preceding node serial number, wherein the third field setting unit does not specify the preceding node serial number when the position is the paramount supervisor position; the fourth field setting unit sets the department serial number of the department related to the position in accordance with the department info to the dependent node serial number; and the fifth field setting unit specifies a serial number of an external system as the inheritance node serial number when the position info is imported from the external system; and the sixth field setting unit sets the node name of the position info to a position name.

For example, if the nodal data comprise a position info, the correlation between positions will be recorded. The field data match the field setting units as shown in Table 2 below.

TABLE 2
correlation between positions

| field 1 | field 2 | field 3 | field 4 | field 5 | field 6 |
|---|---|---|---|---|---|
| 1 | 1 | | | o1 | president office |
| 1 | 2 | 1 | 1 | o2 | general manager |
| | | | | | office |
| 1 | 3 | 2 | 2 | o3 | department A |
| 1 | 4 | 2 | 2 | o4 | department B |
| 1 | 5 | | 1 | p1 | president |
| 1 | 13 | 5 | 1 | p2 | president's |
| | | | | | secretary |
| 1 | 6 | 5 | 2 | p3 | general manager |
| 1 | 7 | 6 | 3 | p4 | manager A |
| 1 | 8 | 7 | 3 | p5 | employee A1 |
| 1 | 9 | 7 | 3 | p6 | employee A2 |
| 1 | 10 | 6 | 4 | p7 | manager B |
| 1 | 11 | 10 | 4 | p8 | employee B1 |
| 1 | 12 | 10 | 4 | p9 | employee B2 |

Referring to FIG. 4, there is shown a schematic view of position framework relationships expressed by nodal data according to an embodiment of the present invention. If the nodal data comprise a workflow design info, the following will occur: the first field setting unit specifies the same route workflows as the same group data and configures the same group serial number; the second field setting unit configures a node serial number of each node within an organizational framework; the third field setting unit configures a preceding node serial number in accordance with a preceding information of each node within the organizational framework; the fourth field setting unit configures the dependent node serial number in accordance with the dependent primary workflow route when the workflow template design data relate to a secondary workflow route; the fourth field setting unit does not configure the dependent node serial number when the workflow template design data relate to the primary workflow route; the fifth field setting unit sets the inheritance node serial number to a department serial number or a position serial number when the workflow template design data comprise an inheritance department info or a position info; and the sixth field setting unit configures the name of each node.

For example, when the nodal data comprise field data related to the workflow design info during the design stage, the field data match the field setting units as shown in Table 3 below.

TABLE 3
field data attributed to nodal data and related
to workflow design info during design stage

| field 1 | field 2 | field 3 | field 4 | field 5 | field 6 |
|---|---|---|---|---|---|
| 3 | 31 | | | | any person |
| 3 | 32 | 31 | | | sign node A |
| 3 | 33 | 32 | | | daughter sign |
| | | | | | sequence A |
| 3 | 34 | 33 | 33 | | sign node A.A |
| 3 | 35 | 34 | 33 | | daughter sign |
| | | | | | sequence B |
| 3 | 36 | 35 | 35 | | sign node B.A |
| 3 | 37 | 36 | 35 | | sign node B.B |
| 3 | 38 | 35 | 33 | | sign node A.B |
| 3 | 39 | 33 | | | sign node B |
| 3 | 40 | 39 | | 8 | employee A1 |
| 3 | 41 | 40 | | 7 | manager A |
| 3 | 42 | 41 | | | sign node C |

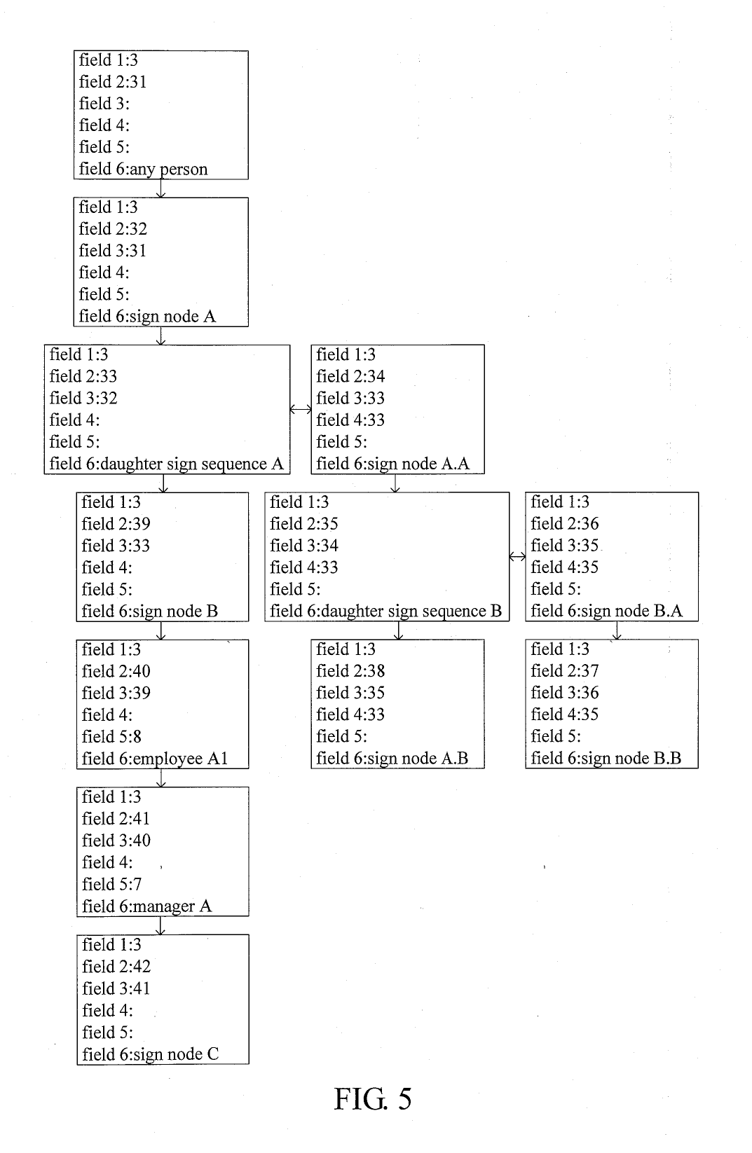

Referring to FIG. 5, there is shown a schematic view of a workflow route comprising expanded field data related to workflow design info in a design stage according to an embodiment of the present invention. If the nodal data comprise a runtime workflow info, the following will occur: the first field setting unit specifies the same route workflow as the same group and configures the same group serial number; the second field setting unit specifies the node serial number as a department serial number; the third field setting unit specifies the preceding information as a supervisory department of the department and sets a department serial number of the supervisory department to the preceding node serial number; the fourth field setting unit configures the dependent node serial number in accordance with the dependent primary workflow route when the workflow template runtime data relate to a secondary workflow route; the fourth field setting unit does not configure the dependent node serial number when the workflow template runtime data relate to the primary workflow route; the fifth field setting unit sets the inheritance node serial number to a department serial number, a position serial number, or a node serial number of workflow template design data when the workflow template runtime data comprise an inheritance department info, a position info, or workflow template design data; and the sixth field setting unit sets a node name of the department info to a department name.

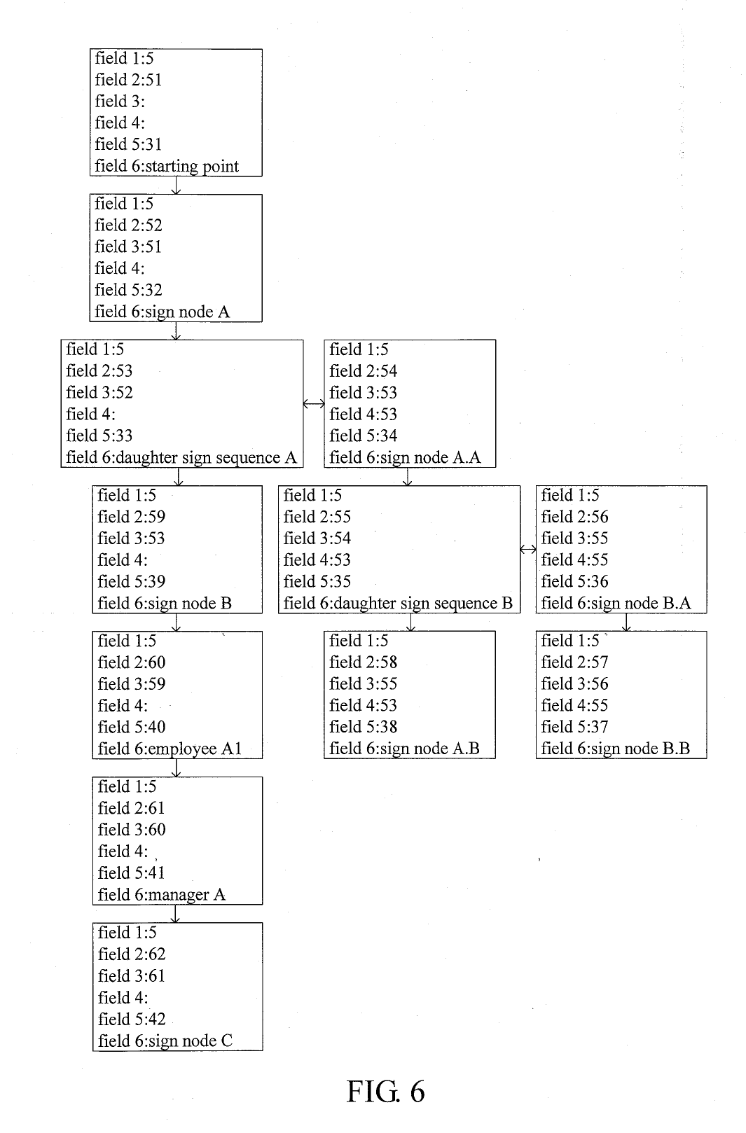

Referring to FIG. 6, there is shown a schematic view of a workflow route comprising expanded field data related to runtime workflow info according to an embodiment of the present invention. If the nodal data comprise a runtime workflow info, the field data will match the field setting units as shown in Table 4 below.

TABLE 4
field data when the nodal data comprise a runtime workflow info

| field 1 | field 2 | field 3 | field 4 | field 5 | field 6 |
|---|---|---|---|---|---|
| 5 | 51 | | | 31 | starting point |
| 5 | 52 | 51 | | 32 | sign node A |
| 5 | 53 | 52 | | 33 | daughter sign |
| | | | | | sequence A |
| 5 | 54 | 53 | 53 | 34 | sign node A.A |
| 5 | 55 | 54 | 53 | 35 | daughter sign |
| | | | | | sequence B |
| 5 | 56 | 55 | 55 | 36 | sign node B.A |
| 5 | 57 | 56 | 55 | 37 | sign node B.B |
| 5 | 58 | 55 | 53 | 38 | sign node A.B |
| 5 | 59 | 53 | | 39 | sign node B |
| 5 | 60 | 59 | | 40 | employee A1 |
| 5 | 61 | 60 | | 41 | manager A |
| 5 | 62 | 61 | | 42 | sign node C |

Accordingly, configuring the nodal data with respect to each node by the field setting units involve the steps below.

Step A: searching for a workflow design info matching a workflow object. That is to say, searching for an information delivery route applicable to the workflow object.

Step B: reproducing the workflow design info to become a runtime workflow info. That is to say, reproducing a Workflow-Design obtained to become an Info Workflow-RuntTime. During the reproduction process, field 1 and field 2 define a new group datum and node serial number in accordance with a new Workflow-Runtime, and another Workflow-Design of field 2 is reproduced and sent to Workflow-Runtime of field 5.

Step C: adjusting a preceding node serial number and a dependent node serial number of the third and fourth field setting units in the runtime workflow info in accordance with correlation between nodes related to the workflow design info, correlation between the second and third field setting units, and correlation between the second and fourth field setting units related to the workflow design info and stored in the fifth field setting unit. That is to say, Workflow-Runtime field 3, field 4 are adjusted to reconstruct a complete data delivery route in accordance with correlation between nodes in field 5 and Workflow-Design, correlation between field 2 and field 3, and correlation between field 2 and field 4 in Workflow-Design

Step D: scanning the runtime workflow info from a starting point, and then repeating step B and step C in case of inheritance. That is to say, scanning Workflow-Runtime from the starting point, and repeating step B and step C in accordance with fields A-D of the nodes in case of inheritance, wherein the resultant Workflow-Runtime is a daughter delivery route of the original Workflow-Runtime. That is to say, field 4 of the resultant Workflow-Runtime Root Processes is labeled as the value of field 2 of the inherited node, and node field 3 of the starting point of the Workflow-Runtime is labeled as the value of field 2 of the inherited node.

Step E: when the inheritance labeling setting unit is configured as the embedded main delivery route, all the values of a daughter delivery route are configured, and the inheritance node is deleted. That is to say, if the inherited node field D value is as root processes, then field 4 of all the nodes at the first level of a daughter delivery route finalized in step D is labeled as field 4 of the inherited node, and node field 3 at the starting point of a daughter delivery route is labeled as field 3 of the inherited node, wherein the next node field 3 of the inherited node is labeled as field 2 at the ending point of a daughter delivery route, before deleting the inherited node.

Step D: delivering the workflow object. That is to say, information delivery is performed until the workflow object is delivered to the inherited node; meanwhile, compare Start Role to determine whether it is the same as it is when step D is carried out. If the determination is negative, a daughter delivery route resulting from step D will be deleted, and then step D will be carried out anew.

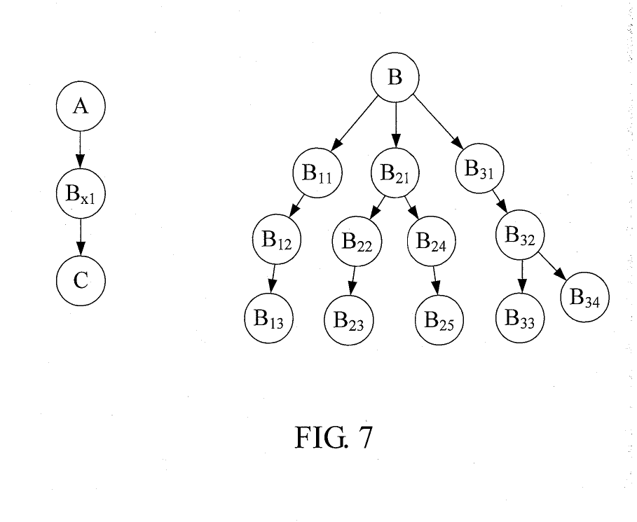

Referring to FIG. 7, there is shown a schematic view of the principle of dynamic automated assembly according to an embodiment of the present invention. The expression A→B_{X3}→C on the left hand side of FIG. 7 denotes a portion of route points of the primary workflow route set forth with a workflow template, wherein B_{X3} denotes route points having a plurality of nodes. B_{X3} route points are expanded as shown on the right hand side of FIG. 3, indicating that, among the B_{X3} route points, B₁₃, B₂₃, and B₃₃, have equal-level nodes; in other words, signing operation can be performed at each of the aforesaid three nodes. Once a signing operation is performed at a node and finished, no signing operation can be performed at the other nodes. For example, after node B₂₃ signing has been finalized, the workflow extension unit 124 extends a secondary workflow route in accordance with the B₂₃ node fed back, wherein the secondary workflow route meets the requirements of the limitation of the group data related to the B₂₃ node and its nodal data rules. For example, given B₂₃→B₂₂→B₂₁, upon completion of the signing of B₂₁ node, the process flow returns to the primary workflow route to continue with the next route point C.

In conclusion, a workflow engine controls a tree structure of “a primary workflow route and a secondary workflow route that branches therefrom” in a workflow. Data are retrieved from a metadata database and a workflow template database and fully displayed under automated assembly to save manpower, reduce error, and enhance accuracy.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A workflow management system, configured for managing a procedure of delivery of a workflow object within an organizational framework, the workflow management system comprising:
a metadata database for storing nodal data within the organizational framework and storing at least a workflow template operating between the nodes, the workflow template each having a plurality of route points, the route points each having at least a node, each said workflow template being defined with group data related to each said node;
an input module for receiving the workflow object; and
an authorizing module linked to the metadata database and the input module, the authorizing module comprising:
a workflow template selection unit for generating according to the at least a workflow template a primary workflow route for the workflow object to operate between the route points; and
a workflow extension unit linked to the workflow template selection unit and adapted to extend a secondary workflow route of a higher level in accordance with a feedback from a node of each route point, limitation of the group data related to the node, and nodal data thereof, so as to operate the workflow object, thereby returning to the primary workflow route upon completion of the secondary workflow route.

2. The workflow management system of claim 1, further comprising:
a field setting unit linked to the metadata database and adapted to configure data related to a sequence of the nodes, the field setting unit comprises:
a first field setting unit for configuring an organizational framework serial number of each node within an organizational framework;
a second field setting unit for configuring a node serial number of each node within an organizational framework;
a third field setting unit for configuring a preceding node serial number in accordance with a preceding information of each node within the organizational framework;
a fourth field setting unit for configuring, when each node depends upon another node, a dependent node serial number in accordance with the node being depend upon;
a fifth field setting unit for configuring an inheritance node serial number in accordance with a serial number of an inherited node when each of the nodes inherits another node; and
a sixth field setting unit for configuring a name of each of the nodes.

3. The workflow management system of claim 2, wherein, when the nodal data comprise a department info, the following occur:
the first field setting unit puts identical organizational frameworks in a same category and configures serial numbers of an identical category;
the second field setting unit specifies the node serial number as a department serial number;
the third field setting unit specifies the preceding information as a supervisory department of the department and sets a department serial number of the supervisory department to the preceding node serial number;
the fourth field setting unit configures the dependent node serial number in accordance with a department serial number of the supervisory department; and
the fifth field setting unit specifies a serial number of an external system as the inheritance node serial number when the department info is imported from an external system; and
the sixth field setting unit sets a node name of the department info to a department name.

4. The workflow management system of claim 3, wherein the nodal data comprise a position info, wherein the first field setting unit specifies identical organizational framework as belonging to identical categories and configures serial numbers of identical categories, the workflow management system is characterized in that:
the second field setting unit specifies the node serial number as a position serial number;
the third field setting unit specifies the preceding information as a position of the position immediate supervisor, sets a position serial number of the immediate supervisor position to the preceding node serial number, and does not specify the preceding node serial number when the position is a paramount supervisor position;
the fourth field setting unit sets a department serial number of a department related to the position to the dependent node serial number in accordance with the department info; and
the fifth field setting unit sets a serial number of an external system to the inheritance node serial number when the position info is imported from an external system; and
the sixth field setting unit sets a node name of the position info to a position name.

5. The workflow management system of claim 4, wherein, when the nodal data comprise workflow template design data, the following occur:
the first field setting unit specifies identical route workflows as identical group data and configures serial numbers of identical groups;
the fourth field setting unit configures the dependent node serial number in accordance with the dependent primary workflow route when the workflow template design data relate to a secondary workflow route and does not configure the dependent node serial number when the workflow template design data relate to the primary workflow route; and
the fifth field setting unit sets the inheritance node serial number to a department serial number or a position serial number when the workflow template design data comprise an inheritance department info or a position info.

6. The workflow management system of claim 5, wherein, when the nodal data comprise workflow template runtime data, the following occur:
the first field setting unit specifies identical route workflows as belonging to identical groups and configures serial numbers of identical groups;
the fourth field setting unit configures the dependent node serial number in accordance with the dependent primary workflow route when the workflow template runtime data relate to a secondary workflow route and does not configure the dependent node serial number when the workflow template runtime data relate to the primary workflow route; and
the fifth field setting unit sets the inheritance node serial number to a department serial number, a position serial number, or a node serial number of workflow template design data when the workflow template runtime data comprise an inheritance department info, a position info, or workflow template design data.

7. A workflow management method for generating a workflow route of a workflow object, comprising the steps of:
A: searching for a workflow template matching the workflow object;
B: operating the workflow object in accordance with each route point of the primary workflow route of the workflow template;
C: extending a secondary workflow route of a higher level in accordance with level sequence data of a node fed back within a group to which the node fed back earliest belongs when route points of the primary workflow route have a plurality of equal-level nodes; and
D: operating the workflow object in accordance with the secondary workflow route, and going back to step B upon completion of the operation to continue with the next route point,
wherein the workflow template regulates a rule of a sequence of a plurality of nodes during operation of the workflow object, has a plurality of route points each having at least a node, and defines group data related to each said node.

8. The workflow management method of claim 7, wherein step C further comprises extending the secondary workflow route of a higher level in accordance with level sequence data of a node fed back within a group to which the node fed back belongs when route points of the primary workflow route have an odd number of nodes.
